(19) United States
(12) Patent Application Publication
(10) Pub. No.: US 2013/0191785 A1
(43) Pub. Date: Jul. 25, 2013

(54) CONFIDENT ITEM SELECTION USING DIRECT MANIPULATION

(71) Applicants: Benjamin Edward Rampson, Woodinville, WA (US); Karen Cheng, Seattle, WA (US); Su-Piao Wu, Sammamish, WA (US)

(72) Inventors: Benjamin Edward Rampson, Woodinville, WA (US); Karen Cheng, Seattle, WA (US); Su-Piao Wu, Sammamish, WA (US)

(73) Assignee: MICROSOFT CORPORATION, Redmond, WA (US)

(21) Appl. No.: 13/356,502

(22) Filed: Jan. 23, 2012

(51) Int. Cl. G06F 3/048; G06F 3/041

(52) U.S. Cl. 715/845

(57) ABSTRACT

A user interface element and a visual indicator are displayed to show both a current selected area that tracks a user's touch input and an indication of any items that are considered to be selected (the potential selection). The user interface element (e.g. a border) is displayed whose size may be adjusted by a user using touch input to select more/fewer items. An item visual indicator is displayed for items that are considered to be a potential selection (e.g. items that would be selected if the touch input were to end at the current time). The item visual indicator is configured to show the user an indication of currently selected items without the border appearing to jump in response to another item being selected/deselected. The item visual indicator helps to avoid the need for a user to re-adjust the selection or get unexpected results.

### BACKGROUND

When working on many mobile computing devices (e.g. smart phones, tablets) the screen real estate and input devices available are often limited making editing and selection of displayed content challenging for many users. For example, not only can the display be limited in size, many devices use touch input and a Software-based Input Panel (SIP) in place of a physical keyboard that can reduce the available area to display content. The display of the content may be much smaller on mobile computing devices making editing and selection difficult for a user.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A user interface element and a visual indicator are displayed to show both a current selected area that tracks a user's touch input and an indication of any items that are considered to be selected (the potential selection). The user interface element (e.g. a border) is displayed whose size may be adjusted by a user using touch input to select more/fewer items. For example, a user may select a corner of the user interface element and drag it to adjust the currently selected area. An item visual indicator is displayed for items that are considered to be a potential selection (e.g. items that would be selected if the touch input were to end at the current time). The potential selection of items may be based on a determination that the current selected area encompasses more than some predetermined area of an item. The item visual indicator may distinguish all/portion of the items within the potential selection from other non-selected items. The item visual indicator is configured to show the user an indication of currently selected items without the border appearing to jump in response to another item being selected/deselected. The item visual indicator helps to provide the user with a clear and confident understanding of the selection that will be made helping to avoid the need for a user to re-adjust the selection or get unexpected results.

### BRIEF DESCRIPTION OF THE DRAWINGS

FIG. 1 illustrates an exemplary computing environment;

FIG. 2 illustrates an exemplary system for selecting items using both a display of a currently selected area and an item visual indicator;

FIG. 3 shows a display illustrating a window that shows a user selecting cells within a spreadsheet;

FIG. 4 shows an illustrative processes for selecting items using touch input;

FIGS. 5-7 illustrate exemplary windows showing a user selecting items; and

FIG. 8 illustrates a system architecture used in selecting items.

### DETAILED DESCRIPTION

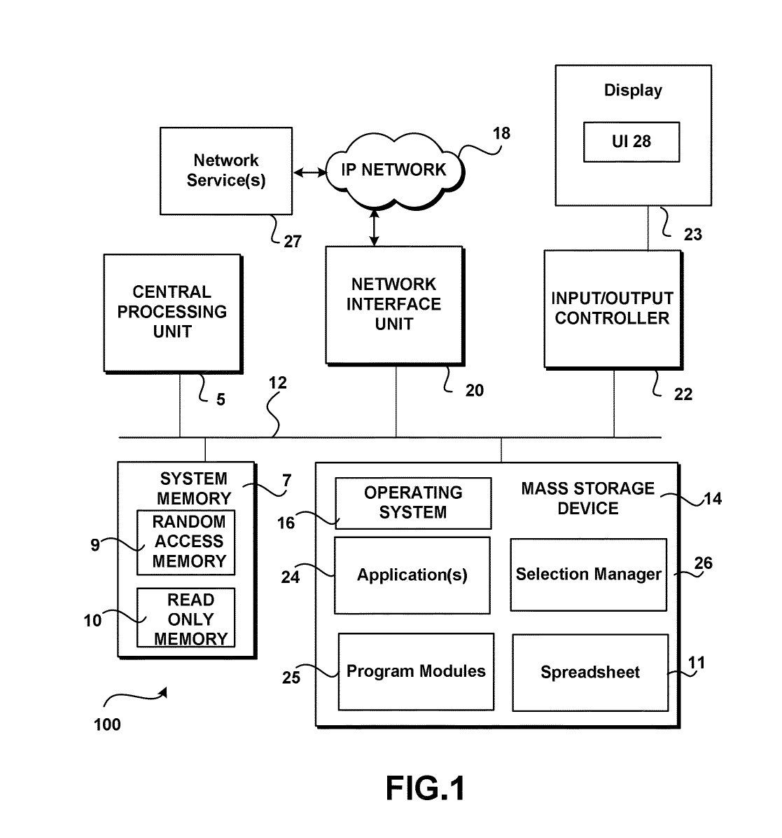

Referring now to the drawings, in which like numerals represent like elements, various embodiment will be described. In particular, FIG. 1 and the corresponding discussion are intended to provide a brief, general description of a suitable computing environment in which embodiments may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an illustrative computer environment for a computer 100 utilized in the various embodiments will be described. The computer environment shown in FIG. 1 includes computing devices that each may be configured as a mobile computing device (e.g. phone, tablet, netbook, laptop), server, a desktop, or some other type of computing device and includes a central processing unit 5 (“CPU”), a system memory 7, including a random access memory 9 (“RAM”) and a read-only memory (“ROM”) 10, and a system bus 12 that couples the memory to the central processing unit (“CPU”) 5.

A basic input/output system containing the basic routines that help to transfer information between elements within the computer, such as during startup, is stored in the ROM 10. The computer 100 further includes a mass storage device 14 for storing an operating system 16, application(s) 24 (e.g. productivity application, spreadsheet application, Web Browser, and the like) and selection manager 26 which will be described in greater detail below.

The mass storage device 14 is connected to the CPU 5 through a mass storage controller (not shown) connected to the bus 12. The mass storage device 14 and its associated computer-readable media provide non-volatile storage for the computer 100. Although the description of computer-readable media contained herein refers to a mass storage device, such as a hard disk or CD-ROM drive, the computer-readable media can be any available media that can be accessed by the computer 100.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, Erasable Programmable Read Only Memory (“EPROM”), Electrically Erasable Programmable Read Only Memory (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 100.

Computer 100 operates in a networked environment using logical connections to remote computers through a network 18, such as the Internet. The computer 100 may connect to the network 18 through a network interface unit 20 connected to the bus 12. The network connection may be wireless and/or wired. The network interface unit 20 may also be utilized to connect to other types of networks and remote computer systems. The computer 100 may also include an input/output controller 22 for receiving and processing input from a number of other devices, including a keyboard, mouse, a touch input device, or electronic stylus (not shown in FIG. 1). Similarly, an input/output controller 22 may provide input/output to a display screen 23, a printer, or other type of output device.

A touch input device may utilize any technology that allows single/multi-touch input to be recognized (touching/non-touching). For example, the technologies may include, but are not limited to: heat, finger pressure, high capture rate cameras, infrared light, optic capture, tuned electromagnetic induction, ultrasonic receivers, transducer microphones, laser rangefinders, shadow capture, and the like. According to an embodiment, the touch input device may be configured to detect near-touches (i.e. within some distance of the touch input device but not physically touching the touch input device). The touch input device may also act as a display. The input/output controller 22 may also provide output to one or more display screens 23, a printer, or other type of input/output device.

A camera and/or some other sensing device may be operative to record one or more users and capture motions and/or gestures made by users of a computing device. Sensing device may be further operative to capture spoken words, such as by a microphone and/or capture other inputs from a user such as by a keyboard and/or mouse (not pictured). The sensing device may comprise any motion detection device capable of detecting the movement of a user. For example, a camera may comprise a MICROSOFT KINECT® motion capture device comprising a plurality of cameras and a plurality of microphones.

Embodiments of the invention may be practiced via a system-on-a-chip (SOC) where each or many of the components/processes illustrated in the FIGURES may be integrated onto a single integrated circuit. Such a SOC device may include one or more processing units, graphics units, communications units, system virtualization units and various application functionality all of which are integrated (or “burned”) onto the chip substrate as a single integrated circuit. When operating via a SOC, all/some of the functionality, described herein, with respect to the Unified Communications via application-specific logic integrated with other components of the computing device/system 100 on the single integrated circuit (chip).

As mentioned briefly above, a number of program modules and data files may be stored in the mass storage device 14 and RAM 9 of the computer 100, including an operating system 16 suitable for controlling the operation of a computer, such as the WINDOWS PHONE 7®, WINDOWS 7®, or WINDOWS SERVER® operating system from MICROSOFT CORPORATION of Redmond, Wash. The mass storage device 14 and RAM 9 may also store one or more program modules. In particular, the mass storage device 14 and the RAM 9 may store one or more application programs, such as a spreadsheet application, word processing application and/or other applications. According to an embodiment, the MICROSOFT OFFICE suite of applications is included. The application(s) may be client based and/or web based. For example, a network service 27 may be used, such as: MICROSOFT WINDOWS LIVE, MICROSOFT OFFICE 365 or some other network based service.

Selection manager 26 is configured to display a user interface element (e.g. UI 28) and a visual indicator to show both a current selected area that tracks a user's touch input and an indication of any items that are considered to be selected as a result of the currently selected area. In response to receiving touch input, selection manager 26 displays a user interface element (e.g. a border) that may be adjusted such that the size of the currently selected area changes in response to updated touch input (e.g. underneath a finger). An item visual indicator is displayed that shows any item(s) that are within the current selected area that are potential selections. For example, when the current selected area as illustrated by the user interface element encompasses more than some predetermined area of an item, the display of the item may be changed (e.g. shaded, highlighted, border . . . ) to indicate the potential selection of the item. The item visual indicator is configured to show the user an indication of currently selected items without the border appearing to jump in response to another item being selected/deselected.

Selection manager 26 may be located externally from an application, e.g. a spreadsheet application or some other application, as shown or may be a part of an application. Further, all/some of the functionality provided by selection manager 26 may be located internally/externally from an application for which the user interface element is used for editing value(s) in place. More details regarding the selection manager are disclosed below.

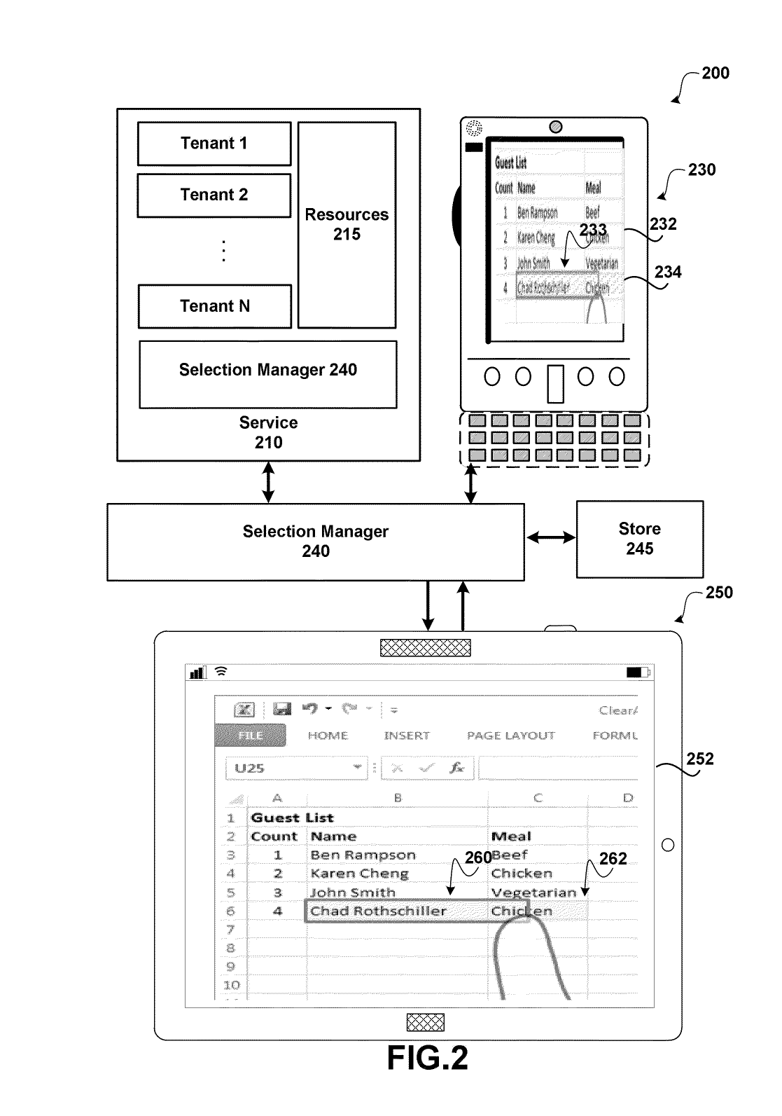

FIG. 2 illustrates an exemplary system for selecting items using both a display of a currently selected area and an item visual indicator. As illustrated, system 200 includes service 210, selection manager 240, store 245, touch screen input device/display 250 (e.g. slate) and smart phone 230.

As illustrated, service 210 is a cloud based and/or enterprise based service that may be configured to provide productivity services (e.g. MICROSOFT OFFICE 365 or some other cloud based/online service that is used to interact with items (e.g. spreadsheets, documents, charts, and the like). Functionality of one or more of the services/applications provided by service 210 may also be configured as a client based application. For example, a client device may include a spreadsheet application that performs operations relating to selecting items using touch input. Although system 200 shows a productivity service, other services/applications may be configured to select items. As illustrated, service 210 is a multi-tenant service that provides resources 215 and services to any number of tenants (e.g. Tenants 1-N). According to an embodiment, multi-tenant service 210 is a cloud based service that provides resources/services 215 to tenants subscribed to the service and maintains each tenant's data separately and protected from other tenant data.

System 200 as illustrated comprises a touch screen input device/display 250 (e.g. a slate/tablet device) and smart phone 230 that detects when a touch input has been received (e.g. a finger touching or nearly touching the touch screen). Any type of touch screen may be utilized that detects a user's touch input. For example, the touch screen may include one or more layers of capacitive material that detects the touch input. Other sensors may be used in addition to or in place of the capacitive material. For example, Infrared (IR) sensors may be used. According to an embodiment, the touch screen is configured to detect objects that in contact with or above a touchable surface. Although the term “above” is used in this description, it should be understood that the orientation of the touch panel system is irrelevant. The term “above” is intended to be applicable to all such orientations. The touch screen may be configured to determine locations of where touch input is received (e.g. a starting point, intermediate points and an ending point). Actual contact between the touchable surface and the object may be detected by any suitable means, including, for example, by a vibration sensor or microphone coupled to the touch panel. A non-exhaustive list of examples for sensors to detect contact includes pressure-based mechanisms, micro-machined accelerometers, piezoelectric devices, capacitive sensors, resistive sensors, inductive sensors, laser vibrometers, and LED vibrometers.

As illustrated, touch screen input device/display 250 and smart phone 230 shows an exemplary display 252/232 of selectable items. Items and documents may be stored on a device (e.g. smart phone 230, slate 250 and/or at some other location (e.g. network store 245). Smart phone 230 shows a display 232 of a spreadsheet including cells arranged in rows and columns that are selectable. The items, such as the cells within a spreadsheet, may be displayed by a client based application and/or by a server based application (e.g. enterprise, cloud based).

Selection manager 240 is configured to perform operations relating to interacting with and selecting items. Items may be selected in response to touch input and/or other input. Generally, items that are selectable are discrete items such as cells, tables, pictures, words, and other objects that are individually selectable.

As illustrated on smart phone 230, a user is in the process of selecting two cells using touch input. The first cell selected includes the value “Chad Rothschiller” and the second cell that is partially selected includes the value “Chicken.” Initially, a user selects an item. The item may be selected using touch input and/or some other input method (e.g. keyboard, mouse, . . . ). In response to the selection, user interface element 233 is initially displayed to show the selection. In the current example, a border is placed around the initially selected cell whose size is adjustable using touch input. As illustrated, the user has selected user interface element 233 and is dragging the edge of the UI element 233 over the cell containing the value “Chicken.” Item visual indicator 234 (e.g. a hash fill in this example) shows the user which cells will be selected based on the current selected area as indicated by UI element 233 (the potential selection). The item visual indicator 234 is displayed for any cell that is determined to be a potential selection (e.g. would be selected if the current touch input ended at the currently selected area of UI element 233). According to an embodiment, an item is selected when more than a predetermined percentage of the item is selected (e.g. 0-100%). For example, item visual indicator 234 may be displayed for any item that is at least 50% enclosed by the currently selected area as indicated by UI element 233. Other item visual indicators and UI elements may be displayed (See exemplary figures and discussion herein).

As illustrated on slate 250, a user is in the process of selecting the same two cells as shown on smart phone 230. UI element 260 is a border that shows the currently selected area and item visual indicator 262 shows a potential selection. In the current example, item visual indicator 262 shows a dimmed border around the remaining portion of the cell including the value “Chicken.”

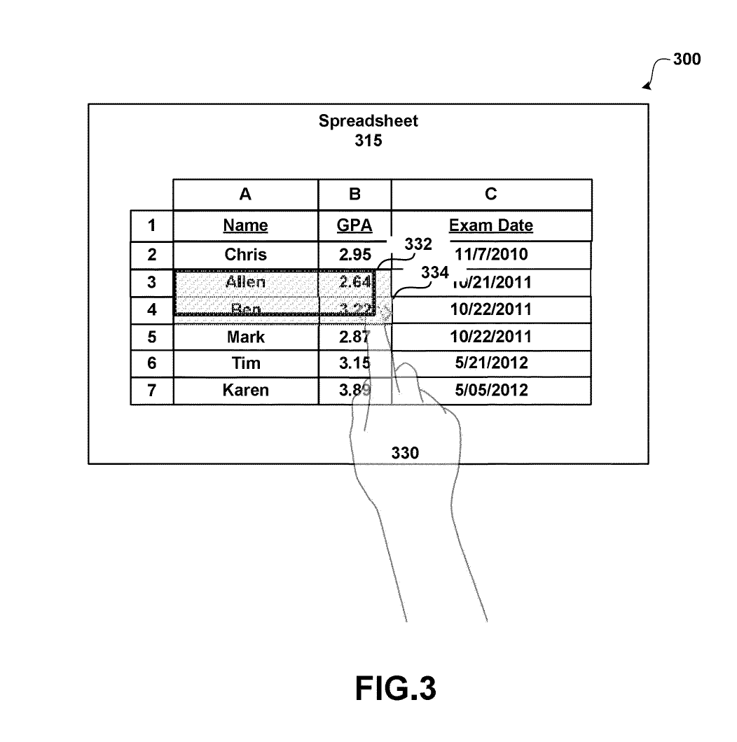

FIG. 3 shows a display illustrating a window that shows a user selecting cells within a spreadsheet. As illustrated, window 300 includes a display of a spreadsheet 315 comprising three columns and seven rows. More or fewer areas/items may be included within window 300. Window 300 may be a window that is associated with a desktop application, a mobile application and/or a web-based application (e.g. displayed by a browser). For example, a web browser may access a spreadsheet service, an spreadsheet application on a computing device may be configured to select items from one or more different services, and the like.

In the current example, a user 330 is in the process of selecting cells A3, A4, B3 and B4 by adjusting a size of UI element 332 using touch input. As illustrated, the UI element 332 is sized by user 330 dragging a corner/edge of the UI element. Item visual indicator 334 displays the items (in this case cells) that would be selected if the user stopped adjusting the size of UI element 332 and ended the touch input (the potential selection). The potential selection in this example includes cells A3, A4, B3 and B4.

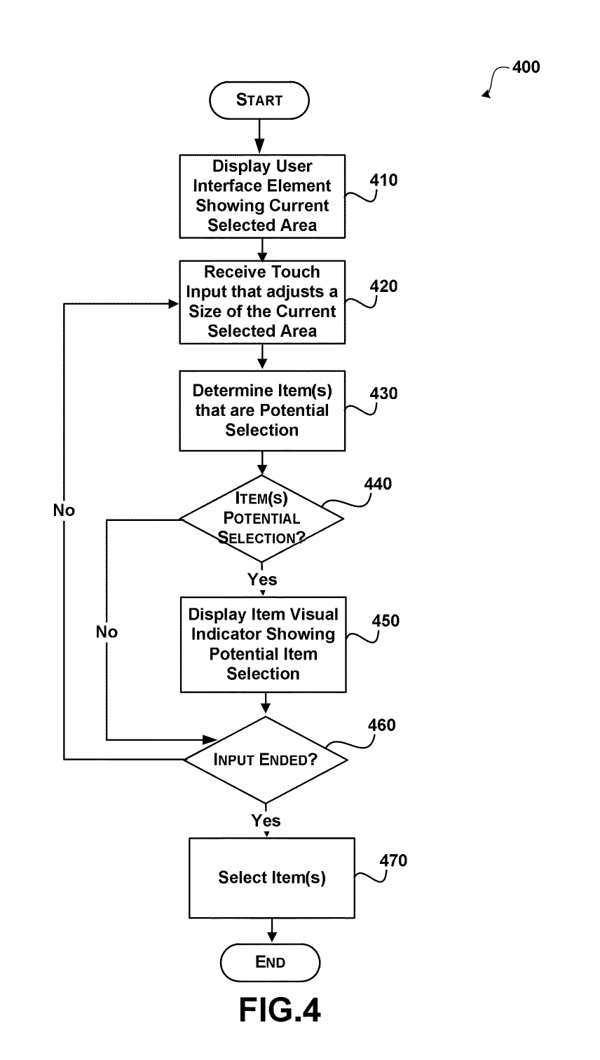

FIG. 4 shows an illustrative processes for selecting items using touch input. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof. While the operations are shown in a particular order, the ordering of the operations may change and be performed in other orderings.

After a start operation, process 400 moves to operation 410, where a user interface element (e.g. a selection border) is displayed that shows the currently selected area/item. For example, a border may be initially displayed around an item (e.g. a cell, chart, object, word, . . . ) in response to an initial selection. One or more handles may/may not be displayed with the user interface element to adjust a size of the current selected area as shown by the user interface element. For example, a user may want to change the size of the selection to include more/less items.

Moving to operation 420, touch input is received to adjust a size of the current selected area of the user interface element. The touch input may be a user's finger(s), a pen input device, and/or some other device that interacts directly with a display/screen of a computing device. For example, the touch input may be a touch input gesture that selects and drags an edge/corner of the displayed user interface element to resize the user interface element. According to an embodiment, the user interface element (e.g. the selection border) is updated during the touch event and appears to stay “pinned” under the user's finger such that the user is clearly able to see the currently selected area as defined by the user.

Transitioning to operation 430, a determination is made as to whether there are any item(s) that are potential selections based on the currently selected area. For example, a user may have resized the current selected area such that the current selected area now encompasses more items. An item may be a potential selection based on various criteria. For example, an item may be considered a potential selection when a predetermined percentage of the item (e.g. 10%, 20%, >50% . . . ) is contained within the currently selected area. According to an embodiment, an item is considered a potential selection as soon as the currently selected area includes any part of an item (e.g. a user adjusts the currently selected area to include a portion of another cell).

Flowing to decision operation 440, a determination is made as whether any items are potential selections. When one or more items is not a potential selection, the process flows to operation 460. When one or more items is a potential selection, the process flows to operation 450.

At operation 450, an item visual indicator is displayed that indicates each item that is determined to be a potential selection. The item visual indicator may include different types of visual indicators. For example, the item visual indicator may include any one or more of the following: changing a shading of an item; showing a different border, changing a formatting of an item, displaying a message showing the potential selection, and the like. As discussed, the item visual indicator provides an indication to the user of any currently selected item(s) without changing the current selection border while a user is adjusting a selection border. In this way, the item visual indicator helps to provide the user with a clear and confident understanding of the selection that will be made helping to avoid the need for a user to re-adjust the selection or get unexpected results.

At decision operation 460, a determination is made as to whether the input has ended. For example, a user may lift their finger off of the display to indicate that they are finished selecting item(s). When input has not ended, the process flows back to operation 420. When input has ended, the process flows to operation 470.

At operation 470, the items that are determined to be potential selections are selected.

The process then flows to an end block and returns to processing other actions.

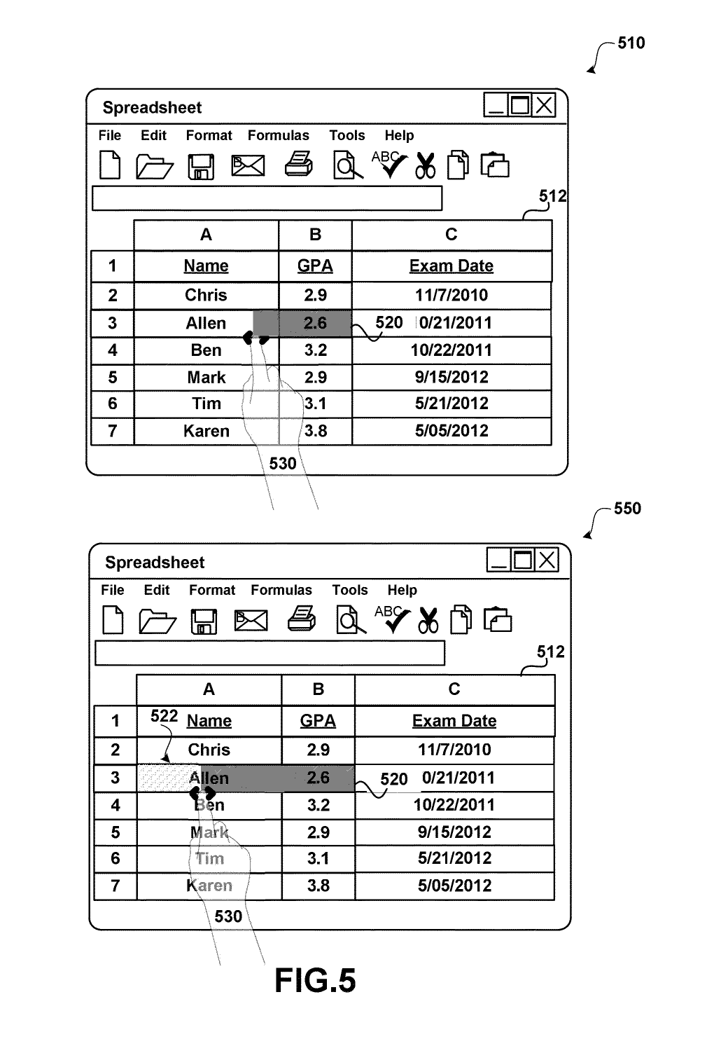

FIGS. 5-7 illustrate exemplary windows showing a user selecting items. FIGS. 5-7 are for exemplary purpose and are not intended to be limiting.

FIG. 5 shows displays for selecting cells within a spreadsheet. As illustrated, window 510 and window 550 each display a spreadsheet 512 that shows a name column, a GPA column, and an exam date column in which a user has initially selected cell B3. More or fewer columns/areas may be included within windows 510 and 550. A window may be a window that is associated with a desktop application, a mobile application and/or a web-based application (e.g. displayed by a browser). The window may be displayed on a limited display device (e.g. smart phone, tablet) or on a larger screen device.

As illustrated, selected cell B3 is displayed differently from the other cells of the spreadsheet to indicate to a user that the cell is currently selected. While cell B3 is shown as being highlighted, other display options may be used to indicate the cell is selected (e.g. border around cell, hashing, color changes, font changes and the like).

In response to receiving an input (e.g. touch input 530) to adjust a size of a currently selected area, UI element 520 is displayed. In the current example, UI element 520 is displayed as a highlighted rectangular region. Other methods of displaying a user interface element to show a currently selected area may be shown (e.g. changing font, placing a border around the item, changing a color of the item, and the like). When the user changes the size of UI element 520, the display of the UI element changes to show the change in size and follows the movement of user's 530 finger. As the user adjusts the size of the currently selected area, one or more items may be determined to be a potential selection.

Window 550 shows the user dragging a left edge of UI element 520 such that it encompasses over half of cell A3. When an item is considered to be a potential cell, an item value indicator 522 is displayed to show the potential selection of the cell (in this example, cell A3). In the current example, a portion of the item (e.g. cell A3) is displayed using a different fill method as compared to UI element 520.

The item value indicator 522 may also be shown using different methods (e.g. no alpha blending, different colors, each complete item that is a potential selection is displayed using the same formatting, . . . ).

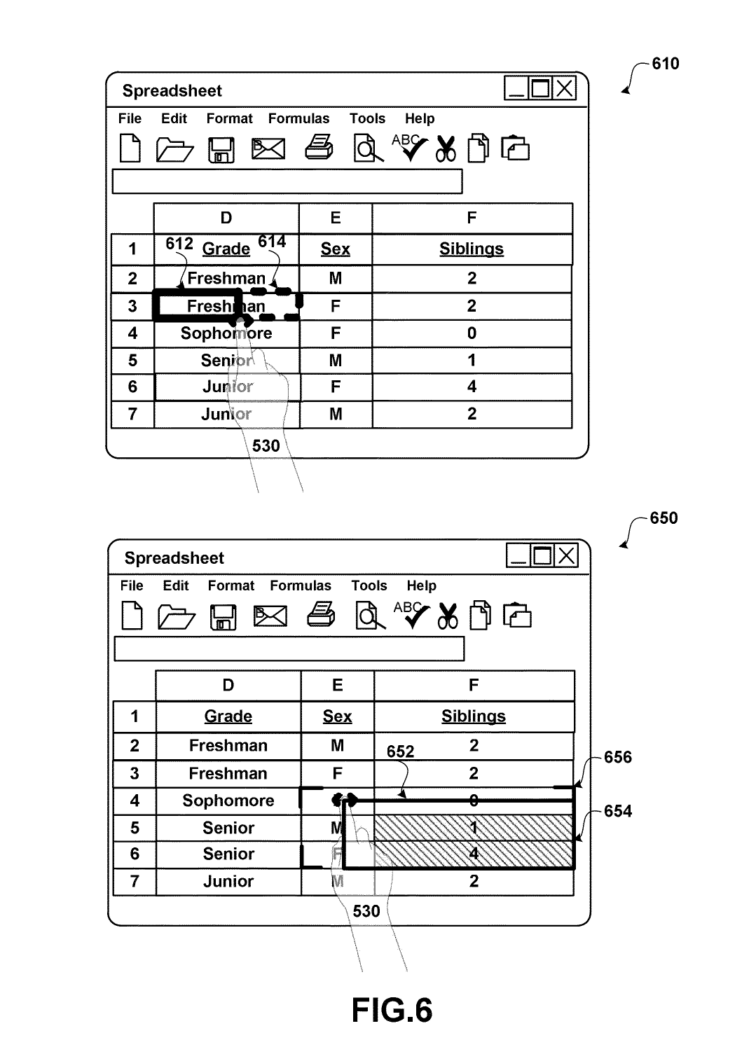

FIG. 6 shows displays for selecting items within a spreadsheet. As illustrated, window 610 and window 650 each include a spreadsheet that currently shows a Grade column, a sex column, and a siblings column.

Window 610 shows a user adjusting a size of a user interface element 612 selection box. The user interface element 612 is displayed as a border around the cell that adjusts in size in response to a user's touch input (e.g. user 530). In response to an item being identified as a potential selection, an item visual selection 614 is displayed that indicates to the user that if the user were to end the current selection, any item that is indicated as a potential selection by the item visual selection 614 would be selected. In the current example, item visual selection 614 is displayed as a different line type as compared to the line type that is used to display the currently selected area.

Window 650 shows a user changing a size of UI selection element 652 to select items. In the current example, items (e.g. cells F5 and F6) that are enclosed within the currently selected area are displayed using a formatting method 654 to show that the items have already been selected. Items that have not been selected yet, but are considered potential selections (e.g. cells E4, E5, E6 and F4) are illustrated as potential selection by the display of item visual selection 656 (e.g. corner brackets).

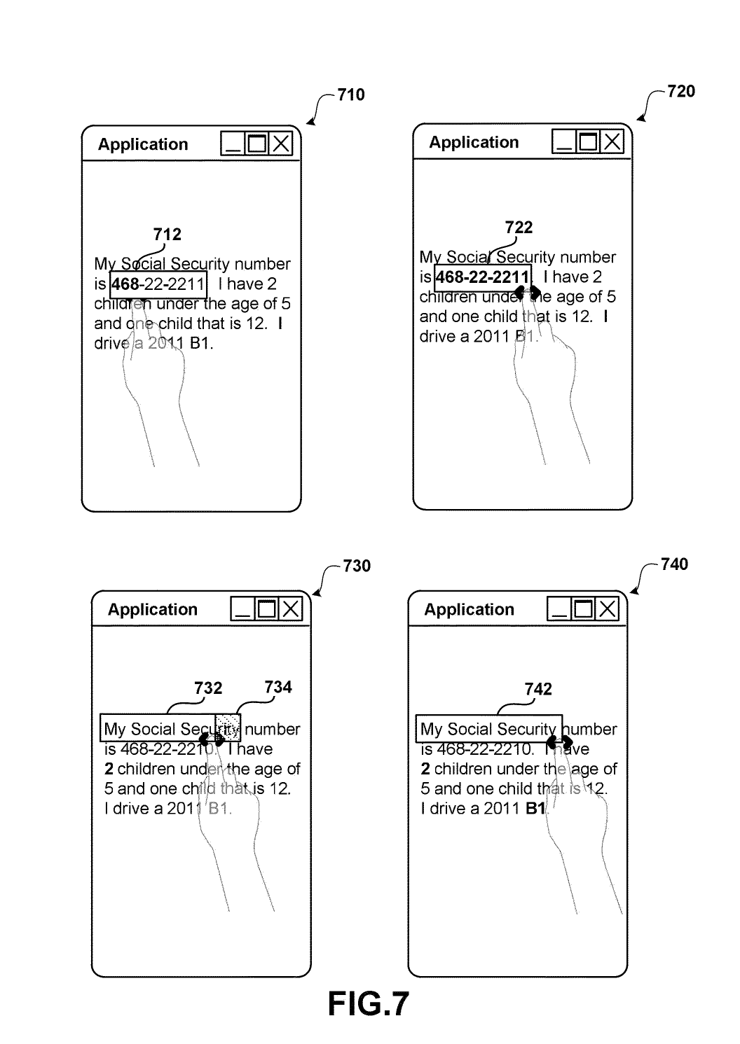

FIG. 7 shows displays for selecting different items within a document. As illustrated, window 710, window 720, window 730 and window 740 each include a display of a document that includes items that may be individually selected.

Window 710 shows a user selecting a social security number within the document. In the current example, as the user drags their finger across the number the formatting of the number changes to show the currently selected area. The item visual selection 712 shows the potential selection (e.g. the entire social security number).

Window 720 shows UI element 722 displayed in response to the entire selection of the social security number.

Window 730 shows a user selecting different words in the document. As the user adjusts the size of user interface element 732, the display is adjusted to show the currently selected area and any items that would be selected if the input were to end using the currently selected area. In the current example, the last portion of “Security” is shown as a potential selection using item visual selection 734.

Window 740 shows a user selecting the words “My Social Security.”

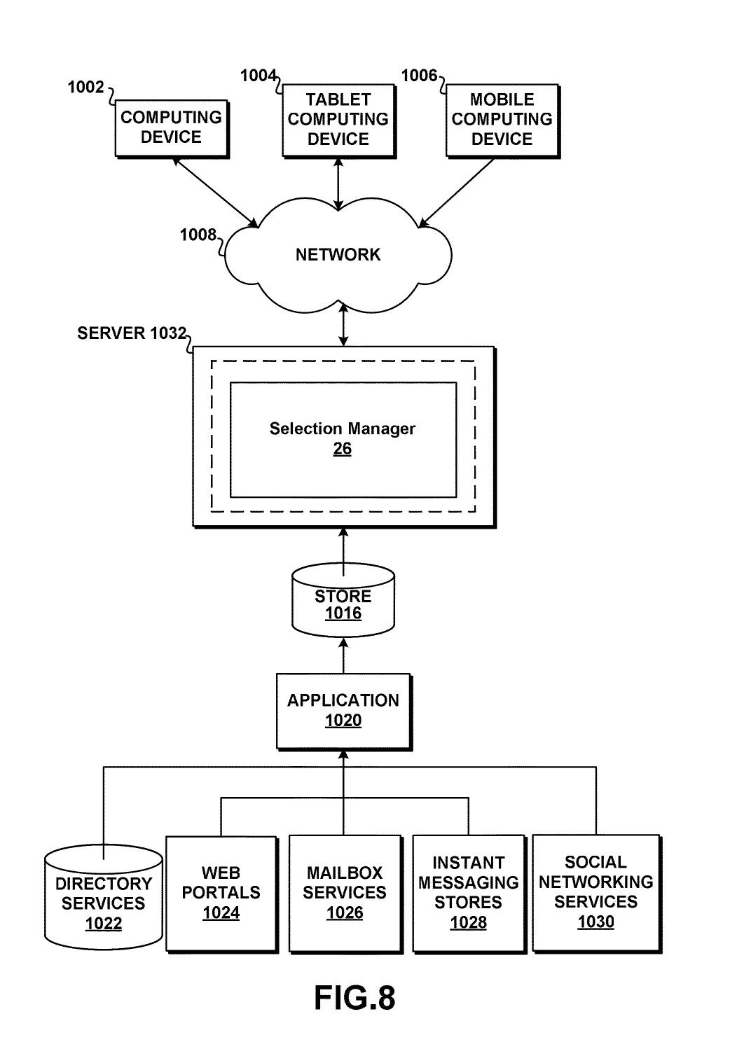

FIG. 8 illustrates a system architecture used in selecting items, as described herein. Content used and displayed by the application (e.g. application 1020) and the selection manager 26 may be stored at different locations. For example, application 1020 may use/store data using directory services 1022, web portals 1024, mailbox services 1026, instant messaging stores 1028 and social networking sites 1030. The application 1020 may use any of these types of systems or the like. A server 1032 may be used to access sources and to prepare and display electronic items. For example, server 1032 may access spreadsheet cells, objects, charts, and the like for application 1020 to display at a client (e.g. a browser or some other window). As one example, server 1032 may be a web server configured to provide spreadsheet services to one or more users. Server 1032 may use the web to interact with clients through a network 1008. Server 1032 may also comprise an application program (e.g. a spreadsheet application). Examples of clients that may interact with server 1032 and a spreadsheet application include computing device 1002, which may include any general purpose personal computer, a tablet computing device 1004 and/or mobile computing device 1006 which may include smart phones. Any of these devices may obtain content from the store 1016.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for selecting items, comprising:
displaying items on a graphical display;
receiving touch input to select one or more of the displayed items; and
while receiving the touch input:
displaying a user interface element on the graphical display that illustrates a current selected area that is updated in response to the touch input changing;
determining each item that is a potential selection using the current selected area;
displaying an item visual indicator on the graphical display that indicates the potential selection when at least one item is determined as the potential selection.

2. The method of claim 1, further comprising determining when the touch input ends and selecting each of the items determined as the potential selection.

3. The method of claim 1, wherein displaying the item visual indicator on the graphical display comprises changing a display of a graphical area that encompasses the potential selection.

4. The method of claim 1, wherein displaying the items on the graphical display comprises displaying a spreadsheet comprising cells arranged in rows and columns, wherein each of the cells is an item.

5. The method of claim 1, wherein determining each item that is the potential selection comprises determining when a predetermined portion of an item is within the current selected area.

6. The method of claim 4, wherein displaying the item visual indicator on the graphical display that indicates the potential selection comprises changing a shading of a cell that includes the display of the potential selection.

7. The method of claim 1, wherein displaying the user interface element and displaying the item visual indicator comprises displaying the current selected area using a first shading and the item visual indicator using a second shading.

8. The method of claim 1, wherein displaying the user interface element and displaying the item visual indicator comprises displaying a border around the current selected area using a first line type and using a second line type to display the item visual indicator.

9. The method of claim 1, wherein displaying the user interface element and displaying the item visual indicator comprises displaying a portion of the item formatted in one way that represents the current selected area of the item and using a second formatting as the item visual indicator.

10. A computer-readable medium storing computer-executable instructions for selecting items, comprising:
displaying items on a graphical display;
receiving touch input that selects an item;
displaying a user interface element on the graphical display that indicates the selected item and a current selected area;
while receiving touch input that adjusts a size of the current selected area:
updating a display of the user interface element that shows the size adjustment of the current selected area;
determining each item that is a potential selection using the current selected area;
displaying an item visual indicator on the graphical display that indicates the potential selection when at least one item is determined as the potential selection.

11. The computer-readable medium of claim 10, further comprising determining when the touch input ends and selecting each of the items determined as the potential selection.

12. The computer-readable medium of claim 10, wherein displaying the item visual indicator on the graphical display comprises changing a display of a graphical area that encompasses the potential selection.

13. The computer-readable medium of claim 10, wherein displaying the items on the graphical display comprises displaying a spreadsheet comprising cells arranged in rows and columns, wherein each of the cells is an item.

14. The computer-readable medium of claim 10, wherein determining each item that is the potential selection comprises determining when a predetermined portion of an item is within the current selected area.

15. The computer-readable medium of claim 10, wherein displaying the user interface element and displaying the item visual indicator comprises displaying the current selected area using a first shading and the item visual indicator using a second shading.

16. The computer-readable medium of claim 10, wherein displaying the user interface element and displaying the item visual indicator comprises displaying a border around the current selected area using a first line type and using a second line type to display the item visual indicator.

17. A system for selecting items, comprising:
a display that is configured to receive touch input;
a processor and memory;
an operating environment executing using the processor;
a spreadsheet application that includes cells that may be selected; and
a selection manager operating in conjunction with the application that is configured to perform actions comprising:
receiving touch input that selects a cell;
displaying a user interface element on the graphical display that indicates the selected cell and a current selected area;
while receiving touch input that adjusts a size of the current selected area:
updating a display of the user interface element that shows the size adjustment of the current selected area;
determining each cell that is a potential selection using the current selected area;
displaying an item visual indicator on the graphical display that indicates the potential selection when at least one cell is determined as the potential selection.

18. The system of claim 17, wherein determining each cell that is the potential selection comprises determining when a predetermined portion of a cell is within the current selected area.

19. The system of claim 17, wherein displaying the user interface element and displaying the item visual indicator comprises displaying the current selected area using a first shading and the item visual indicator using a second shading.

20. The system of claim 17, wherein displaying the user interface element and displaying the item visual indicator comprises displaying a border around the current selected area using a first line type and using a second line type to display the item visual indicator.
